(19) United States
(12) Patent Application Publication
(10) Pub. No.: US 2004/0094131 A1
(43) Pub. Date: May 20, 2004

(54) Fuel delivery check valve for automotive application

(75) Inventors: DeQuan Yu, Ann Arbor, MI (US); Stephen T. Kempfer, Canton, MI (US); Kevin C. Reising, West Bloomfield, MI (US)

Correspondence Address: VISTEON 29074, BRINKS HOFER GILSON & LIONE, P.O. BOX 10395, CHICAGO, IL, 60611, US

(73) Assignee: Visteon Global Technologies, Inc.

(21) Appl. No.: 10/298,380

(22) Filed: Nov. 18, 2002

(51) Int. Cl. F02M 1/00

(52) U.S. Cl. 123/510

(57) ABSTRACT

A check valve assembly is disclosed for use in a returnless automotive fuel delivery system. The fuel delivery system includes a fuel tank having a fuel pump and a sender flange that provides access into the fuel tank. The check valve assembly includes an upper housing that is integral with an interior wall of the sender flange, a lower housing connected to the upper housing and a check valve body positioned between the upper housing and the lower housing. The assembly may also include a pressure relief valve positioned between the upper and lower housings and arranged parallel to the check valve body.

### BACKGROUND

1. Technical Field

This invention relates generally to the automotive fuel delivery field, and more specifically to an improved check valve assembly in the automotive fuel delivery field.

2. Description of the Related Art

It is known to use fuel delivery check valves in automotive fuel delivery systems. The check valve is designed to serve a dual purpose. First, the valve maintains fuel in the fuel line when the engine is off. Second, the valve prevents fuel from leaking out of the fuel tank in the event the tank is over-turned.

Fuel delivery check valves are typically positioned within the fuel tank between the fuel pump and the sender flange. In such a design, there is hosing that runs between the fuel pump and the check valve and from the check valve to the sender flange.

One disadvantage of the above design is that if the hosing between the check valve and the sender flange ruptures, the benefits of the check valve will be minimized. Therefore, it is desirable to position the check valve as close as possible to the fuel's exit path from the tank.

Another disadvantage of positioning the check valve further away from the fuel's exit path is that it is expensive and complex to incorporate a separate check valve component into the design of an already complex fuel delivery system. In fact, these systems are becoming even more complex due to the increasing use of mechanical returnless fuel systems and electrical returnless fuel systems.

Thus, there is a need in the fuel delivery field to create a less complex fuel delivery check valve that is positioned as close as possible to the fuel's exit path from the fuel tank. This invention provides such an improved fuel delivery check valve.

### SUMMARY OF INVENTION

The present invention addresses the needs outlined above by providing an improved check valve assembly for use in a returnless automotive fuel system. The fuel system includes a fuel tank having a fuel pump positioned within the tank and a sender flange that provides access into the fuel tank. The check valve assembly of the present invention includes a check valve body and housing, where a portion of the housing is integral with the sender flange of the fuel tank.

More specifically, the check valve assembly includes an upper housing, a lower housing and the check valve body positioned between the upper housing and the lower housing. The upper housing is integrated into an interior wall of the fuel tank sender flange. Therefore, the check valve and the housing are positioned directly adjacent the fuel's exit path from the fuel tank.

This design is advantageous because it requires fewer parts and is therefore less complex than known fuel check valves. Further, the more simplified design results in a lower cost to manufacture and assemble the component.

These and other aspects and advantages of the present invention will become apparent upon reading the following detailed description of the invention in combination with the accompanying drawings.

### BRIEF DESCRIPTION OF THE DRAWINGS

FIG. 1 is a partial cut-away view of the present invention in a fuel tank; and

FIG. 2 is a cross sectional view of a second embodiment of the present invention.

### DETAILED DESCRIPTION OF THE INVENTION

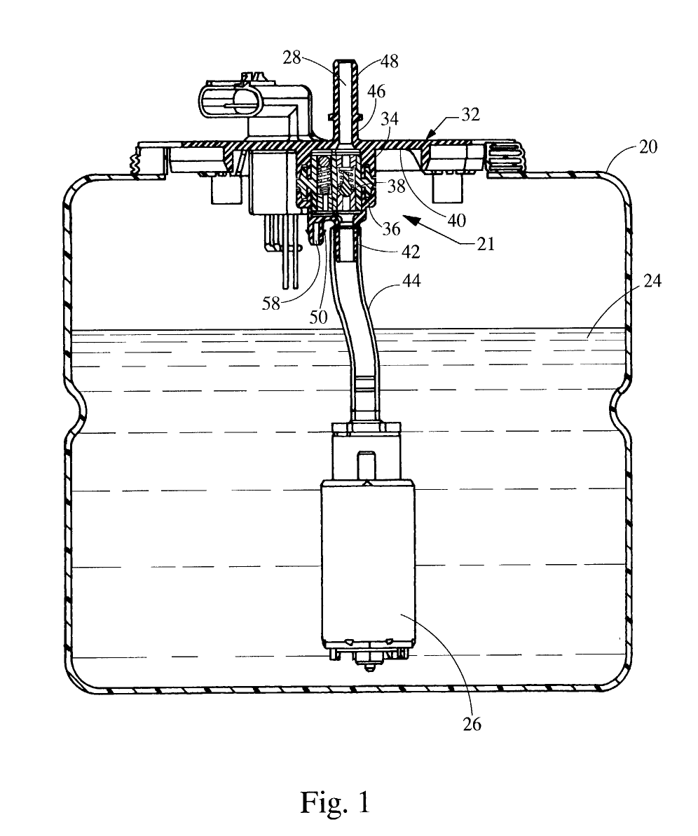

FIG. 1 illustrates a check valve assembly 21 of the present invention positioned within a fuel tank 20 in an automotive vehicle (not shown) having a returnless fuel delivery system. The fuel tank 20 contains the fuel 24 used to power the engine of the vehicle. Positioned within the fuel tank 20 is a fuel pump 26 that pumps the fuel 24 through the fuel line 28 from the tank 20 and ultimately to the fuel rail (not shown). A sender flange 32 provides access into the fuel tank 20.

The check valve assembly 21 includes an upper housing 34, a lower housing 36 connected to the upper housing 34 and a check valve body 38 positioned between the upper housing 34 and the lower housing 36. The upper housing 34 is integrated and extends inwardly (relative to the fuel tank 20) from an interior wall 40 of the fuel tank sender flange 32. The interior wall 40 of the sender flange 32 faces the interior of the fuel tank 20.

The sender flange 32 and the upper housing 34 may be either unitary or integrated. If it is a unitary component, then they are formed as one piece. If it is an integrated component, then they are two separate components joined together.

The lower housing 36 includes an inlet 42 adapted to receive hosing 44 from the fuel pump 26. Similarly, the upper housing 34 includes an outlet 46 adapted to receive hosing 48 that will ultimately run to the fuel rail. These features are present whether the fuel delivery system is a mechanical returnless fuel system or an electronic returnless fuel system.

In the case of the electronic returnless fuel system, the check valve assembly 21 further includes a pressure relief valve 50 arranged parallel to the check valve body 38 and is also referred to as a parallel pressure relief valve (“PPRV”). The parallel pressure relief valve 50 opens, when the pump and the engine are off, to allow fuel flow from the fuel line to the output side of the fuel pump 26 when the fuel line is overpressurized.

It is important to note that the housing 34, 36 is the same whether only the check valve body 38 is present or the check valve body 38 along with the parallel pressure relief valve 50 is present. When the upper housing 34 and the lower housing 36 are attached an interior chamber 52 is formed including a first section 54 and a second section 56. The first section 54 is adapted to receive the check valve body 38. The second section 56 is adapted to receive the parallel pressure relief valve 50.

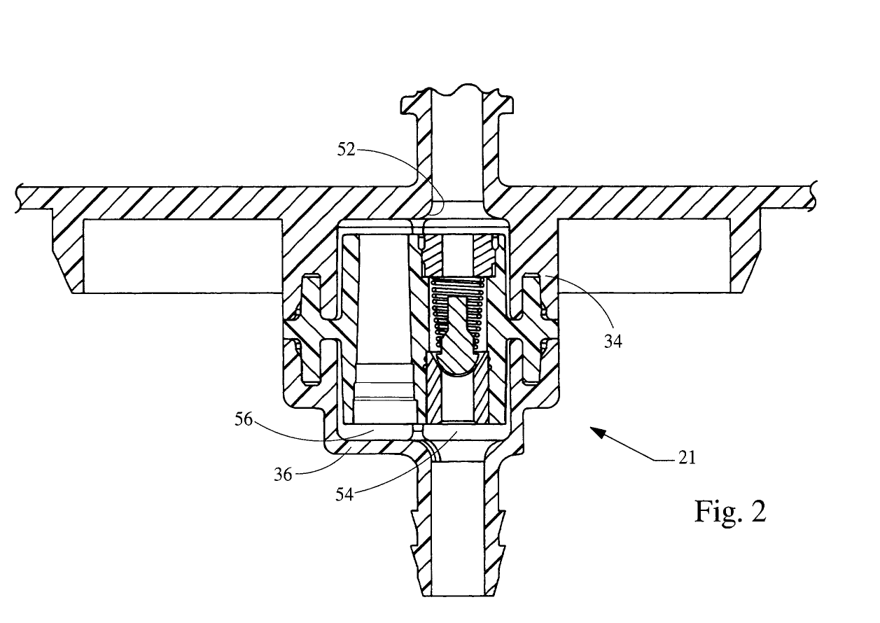

In the case of the mechanical returnless fuel system, illustrated in FIG. 2, when the parallel pressure relief valve 50 is not present, the second section 56 of the interior chamber 52 is plugged off so that no fluid is allowed to flow into the second chamber 56 of the housing 34, 36.

In another embodiment, a bleed port 58 is integrated into the lower housing 36 adjacent to the inlet 42. The bleed port 58 is necessary only when there is no fuel delivery module used in the fuel delivery system.

As a person skilled in the art of fuel delivery systems will recognize from the previous detailed description and from the figures and claims, modifications and changes can be made to the preferred embodiments of the invention without departing from the scope of this invention defined in the following claims.

We claim:

1. A check valve assembly for use in a returnless automotive fuel system having a fuel tank and a fuel pump positioned within the fuel tank, a sender flange adapted to engage the fuel tank and adapted to be removable to provide access therein; said check valve assembly comprising:
an upper housing integrated into an interior wall of said sender flange;
a lower housing connected to the upper housing; and
a check valve body positioned between said upper housing and said lower housing.

2. The check valve assembly of claim 1 wherein said lower housing includes an inlet adapted to receive hosing that contains fuel traveling from the fuel pump.

3. The check valve assembly of claim 1 wherein said upper housing includes an outlet adapted to receive hosing that contains fuel traveling from said check valve body.

4. The check valve assembly of claim 1 wherein said lower housing further includes a bleed port.

5. The check valve assembly of claim 1 wherein said upper housing and said lower housing when connected define an interior chamber.

6. The check valve assembly of claim 5 wherein the interior chamber includes a first section and a second section.

7. The check valve assembly of claim 6 wherein said check valve body is positioned within the interior chamber first section.

8. The check valve assembly of claim 7 further comprising a parallel pressure relief valve positioned between said upper housing and said lower housing.

9. The check valve assembly of claim 8 wherein said parallel pressure relief valve is positioned within the interior chamber second section.

10. A check valve assembly for use in a returnless automotive fuel system including a fuel tank, said check valve assembly comprising:
a sender flange adapted to engage and provide access into the fuel tank;
a housing depending from an interior wall of said sender flange, said housing defining an interior chamber having a first section and a second section, said second section arranged parallel to said first section;
a check valve body positioned in said interior chamber first section; and
a pressure relief valve positioned in said interior chamber second section.
